(19) United States
(12) Patent Application Publication
(10) Pub. No.: US 2009/0037929 A1
(43) Pub. Date: Feb. 5, 2009

(54) Secure Inter-Process Communications Using Mandatory Access Control Security Policies

(75) Inventors: Spencer R. Shimko, Halethorpe, MD (US); Joshua J. Brindle, Columbia, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Tresys Technology, LLC, Columbia, MD (US)

(21) Appl. No.: 11/830,540

(22) Filed: Jul. 30, 2007

(51) Int. Cl. G06F 13/00

(52) U.S. Cl. 719/312

(57) ABSTRACT

The present invention provides secure inter-process communications, and applications thereof. In an embodiment, a shared memory and a message queue are used to provide a secure communication channel between a first computer process and a second computer process. The shared memory provides a path for high-bandwidth data transfer in a forward direction. The message queue provides a path for controlling the data transfer in the forward direction, while limiting data transfer in the reverse direction. A third computer process creates the message queue that is used by the first computer process and the second computer process to control the passage of data. Access to the shared memory and the message queue are enforced using a mandatory access control security policy.

### STATEMENT UNDER MPEP 310

The U.S. government has a paid-up license in this invention and the right in limited circumstances to require the patent owner to license others on reasonable terms as provided for by the terms of Contract No. ______, awarded by ______.

### FIELD OF THE INVENTION

The present invention is generally directed to computer security. More particularly, it is directed to securing inter-process communications in a computer, and applications thereof.

### BACKGROUND OF THE INVENTION

Many computer operating systems have a security mechanism commonly referred to as access control. There are two main types of access control—discretionary access control and mandatory access control.

Under discretionary access control, system resources have security attributes (e.g., read/write/execute permission flags and/or access control lists) associated with them. Access to system resources is controlled based on these security attributes, which are used to protect the system resources (e.g., files) owned by one user from unauthorized access by other users. A weakness associated with discretionary access control is that the security attributes assigned to each system resource are specified by the resource owner and can be modified or removed at will. During a computer attack, an attacker may be able to alter discretionary access control security attributes and thereby gain access to any or all system resources.

Under mandatory access control, access to system resources is controlled by security attributes that cannot be modified or removed during normal operation. Because of this feature, mandatory access control offers a greater level of security than discretionary access control. One form of mandatory access control is type enforcement. Type enforcement is implemented, for example, in security-enhanced Linux (SELinux). In type enforcement, both applications and system resources are assigned type labels. Access for a type enforcement system such as SELinux is defined by a collection of rules contained in a file called a policy. A policy file is loaded into the operating system of a machine during the boot process.

Although mandatory access control (such as, e.g., type enforcement) provides a greater level of security than discretionary access control, available mandatory access control techniques for providing secure inter-process communications (e.g., by eliminating back channels through real-time guarantees of delivery) have a limited bandwidth and cannot meet the desired information flow requirements of many applications. Consequently, new techniques are needed for providing secure, high-bandwidth inter-process communications.

### BRIEF SUMMARY OF THE INVENTION

The present invention provides secure inter-process communications using mandatory access control security policies, and applications thereof. In an embodiment of the present invention, a first computer process passes data to a second computer process via a shared memory. The first computer process is granted write access to the shared memory, and the second computer process is granted read-only access to the shared memory. A third computer process creates a single-entry message queue that is used by the first computer process and the second computer process to control the passage of data via the shared memory. The third computer process is precluded from reading data from or writing data to the message queue. Access to the shared memory and the message queue are enforced using a mandatory access control security policy.

In an embodiment, the first computer process passes data to the second computer process by writing data to be passed to the second computer process in the shared memory. The first computer process then writes a first message to the message queue that indicates to the second computer process that there is data available to be read from the shared memory. When the second computer process reads the first message in the message queue, the second computer process knows to read the data from the shared memory. The first computer process writes another message to the message queue, after the first message, which when read by the second computer process indicates to the first computer process that the data written to the shared memory has been read by the second computer process and may be over-written by new data.

It is a feature of the present invention that the amount of the shared memory, and thus the bandwidth available for secure inter-process communications, can be specified to meet the desired information flow requirements of any application.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts an example machine that provides secure inter-process communications.

FIG. 2 depicts an example secure communication channel that includes two forms of inter-process communications in accordance with an embodiment of the present invention.

FIGS. 3-8 depict example operations of the secure communication channel of FIG. 2 in accordance with embodiments of the present invention.

FIG. 9 depicts an example timing diagram during operation of a secure communication channel in accordance with an embodiment of the present invention.

FIG. 10 depicts a plurality of secure communication channels chained together in series in accordance with an embodiment of the present invention.

FIG. 11 depicts another example secure communication channel that includes a first and a second message queue in accordance with an embodiment of the present invention.

FIG. 12 depicts a diagram of an example computer system.

The features and advantages of the present invention will become more apparent from the detailed description set forth below when read in conjunction with the drawings. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The present invention provides secure inter-process communications using mandatory access control security policies, and applications thereof. In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In an embodiment of the present invention, a first computer process passes data to a second computer process via a first inter-process communication channel of a first type. The first computer process is granted write access to the first inter-process communication channel, and the second computer process is granted read-only access to the first inter-process communication channel. A third computer process creates a second inter-process communication channel of a second type. The second inter-process communication channel is used by the first computer process and the second computer process to control the passage of data via the first inter-process communication channel. The third computer process is precluded from reading data from or writing data to the second inter-process communication channel. Access to the first inter-process communication channel and the second inter-process communication channel are enforced using a mandatory access control security policy.

Aspects of the present invention are described in more detail below in terms of the Linux operating system. This is for illustrative purposes only, and not limitation. In terms of the Linux operating system, the first inter-process communication channel and the second inter-process communication channel may be implemented as a shared memory and message queue, respectively.

For example, in an embodiment of the present invention, the first computer process passes data to the second computer process via the shared memory. The first computer process is granted write access to the shared memory, and the second computer process is granted read-only access to the shared memory. The third computer process creates a single-entry message queue that is used by the first computer process and the second computer process to control the passage of data via the shared memory. The third computer process is precluded from reading data from or writing data to the message queue. Access to the shared memory and the message queue are enforced using SELinux.

This embodiment and other embodiments are described in more detail below.

### II. Example System

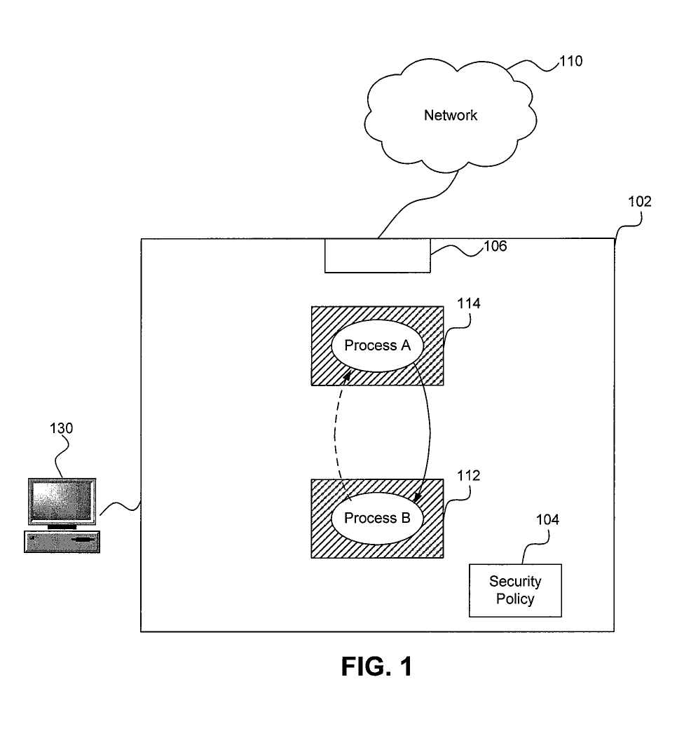

FIG. 1 illustrates an example machine 102 that provides a secure communication channel by using two forms of inter-process communications in accordance with an embodiment of the present invention. Machine 102 includes a display 130, and may be coupled to a network 110 via a network interface 106 (such as, for example, an Ethernet card). Machine 102 is configured to execute a process A, a process B, and a security policy 104 (such as, for example, an SELinux security policy). SELinux is described in more detail, for example, in Bill McCarty, SELinux: NSA's Open Source Security Enhanced Linux (Andy Oram ed., 2005), and Frank Mayer et al., SELinux by Example (Prentice Hall, 2007), both of which are incorporated by reference herein.

Security policy 104 provides security 114 for process A and security 112 for process B. In terms of secure inter-process communications, the goal of security 114 and 112 is to allow data transfer in a forward direction (e.g., from process A to process B), but to limit (or prevent) data transfer in the reverse direction (e.g., from process B to process A).

Shared memory can be used to quickly transfer data from process A to process B in accordance with industry specifications. Security policy 104 can enforce shared memory directionality (e.g., read→write). For example, security policy 104 can ensure that process A has write access to the shared memory, and process B has only read access to the shared memory. In this way, process A can quickly pass large amounts of data to process B via the shared memory, but process A is prevented from surreptitiously reading any privileged data from process B.

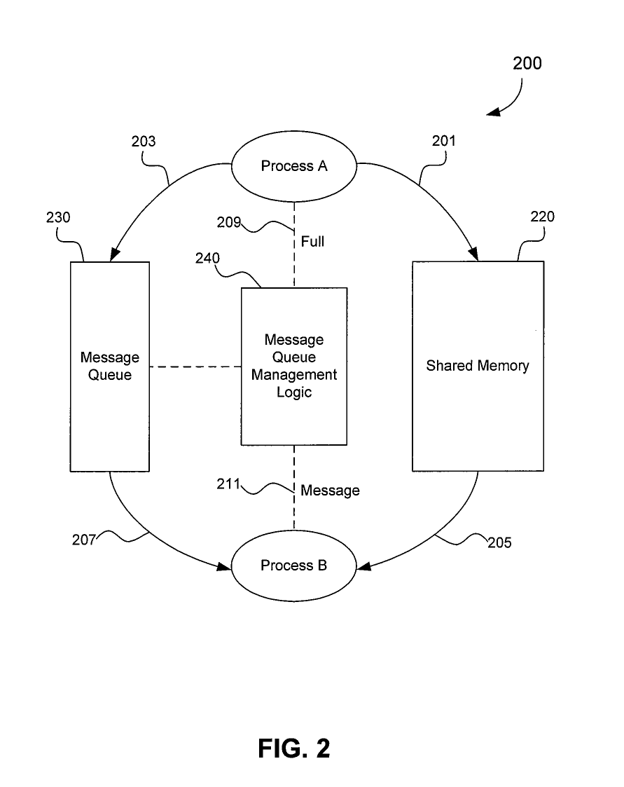

FIG. 2 depicts an example secure communication channel 200 between process A and process B in accordance with an embodiment of the present invention. Secure communication channel 200 between process A and process B includes a shared memory 220, a message queue 230, and message queue management logic 240.

Shared memory 220 provides a high-throughput forward data path between process A and process B. Process A has write access to shared memory 220 via a data path 201, and process B has only read access to shared memory 220 via a data path 205.

Message queue 230 provides a path for controlling the flow of data through shared memory 220, while limiting the backward flow of information from process B to process A. Process A has write access to message queue 230 via a data path 203, and process B has only read access to message queue 230 via a data path 207.

Message queue management logic 240 communicates two different types of status information regarding message queue 230 to processes A and B via control paths 209 and 211, respectively. First, message queue management logic 240 informs process A whether message queue 230 is full or not. If message queue 230 is full, message queue management logic 240 enforces a blocking characteristic whereby process A is prevented from writing any messages to message queue 230. Second, message queue management logic 240 informs process B whether there is a message in message queue 230 that is ready to be read. If message queue management logic 240 indicates that there is a message ready to be read in message queue 230, process B is permitted to read the message.

If message queue 230 is sized to receive only a single message, the two types of status information communicated by message queue management logic 240 can be exploited to provide a secure manner for controlling the passage of data through shared memory 220. For example, process A can be signaled to write to shared memory 220 based on when message queue 230 is emptied by process B, and process B can be signaled to read from shared memory 220 based on when message queue 230 is filled by process A, as described in more detail below.

To use message queue 230 securely, a helper process (e.g., a process other than processes A or B) creates message queue 230, but does not use it. For example, in the case of SELinux, the helper process can call the msgget function with the IPC_CREAT flag indicating the helper process is creating message queue 230. SELinux policy can ensure that the helper process is permitted to create message queue 230, but not to use it for any other operation.

After message queue 230 is created, process A associates with message queue 230 and sets the size of message queue 230 to contain the necessary control information. The size of message queue 230 is important for the flow of the forward channel. Although altering the size of message queue 230 may break the forward channel, it will not introduce any additional back channels. Thus, allowing process A to set the attributes of message queue 230 is not a risk from a security perspective. For illustrative purposes, message queue 230 is set to a size of one (e.g., full or not full) in the example operations described below.

Security policy 104 can include access controls to prevent process A from creating message queue 230, while permitting process A to associate and subsequently use message queue 230 for data transfer. Such access controls reduce the possibility of an attacker creating a plurality of message queues for use as a bit-map to transmit data through a back channel by leveraging error conditions.

Process B also associates with message queue 230. Once both processes A and B have associated with message queue 230, the control channel is ready for use.

In an embodiment, process A creates shared memory 220, and attaches shared memory 220 to its own address space, after both processes A and B have associated with message queue 230. Relying on process A to create shared memory 220 eliminates the back channel introduced through the EEXIST error condition. SELinux policy can be written to enforce this principle.

In another embodiment, a helper process (such as the process that created message queue 230) creates shared memory 220.

Process B associates and attaches to shared memory 220 in a read-only mode. The path from process A to process B through shared memory 220 provides the high-throughput data channel. After attaching shared memory 220 to its address space, process B calls msgrcv and immediately blocks.

After the data channel (which includes shared memory 220) and the control channel (which includes message queue 230) have been created the infrastructure is in place to support inter-process communications that is capable of providing high-throughput forward data transfer while minimizing the throughput of the back channel.

It is noted that while the above example embodiment is described with references to specific features of SELinux, the references are for illustrative purposes only, and not limitation. A person skilled in the relevant art(s) will understand how to establish secure communication channel 200 in other computing environments given the description herein.

### III. Example Operation

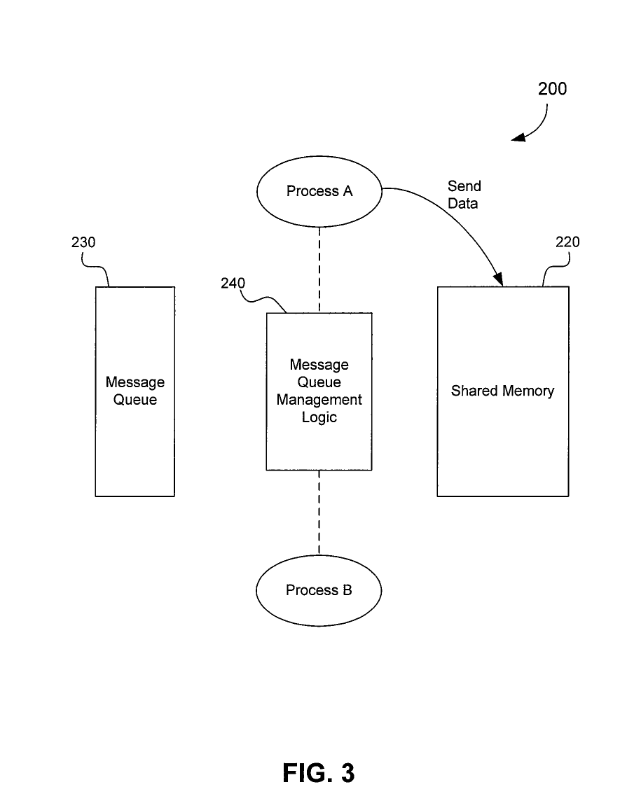

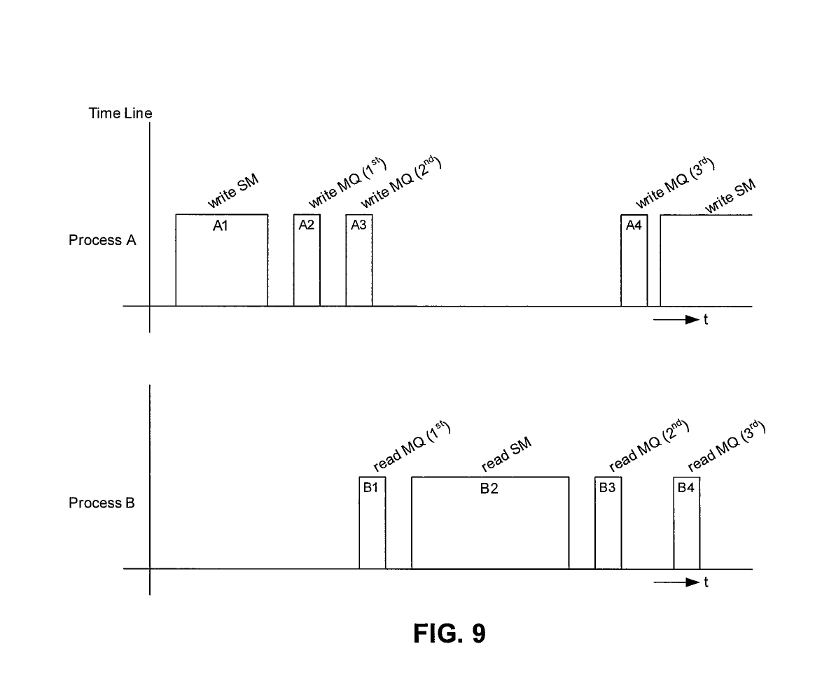

Example pseudo code that may be implemented by processes A and B to communication via secure communication channel 200 is presented below. The pseudo code is described below with continuing reference to FIGS. 3-8 (which depict example states of secure communication channel 200) and FIG. 9 (which depicts an example timing diagram).

Write Loop (Process A)

| | |
|---|---|
| A1 write shared memory | fill shared memory |
| A2 write message queue | Data Ready message |
| A3 write message queue | first No Op message |
| A4 write message queue | second No Op message |
| A5 return to A1 | |

Read Loop (Process B)

| | |
|---|---|
| B1 read message queue | data ready message |
| B2 read shared memory | process shared memory |
| B3 read message queue | first No Op message |
| B4 read message queue | second No Op message |
| B5 return to B1 | |

Referring to FIG. 3, process A begins to fill shared memory 220 (line A1). Process B waits for a message from message queue management logic 240 indicating that there is a message in message queue 230.

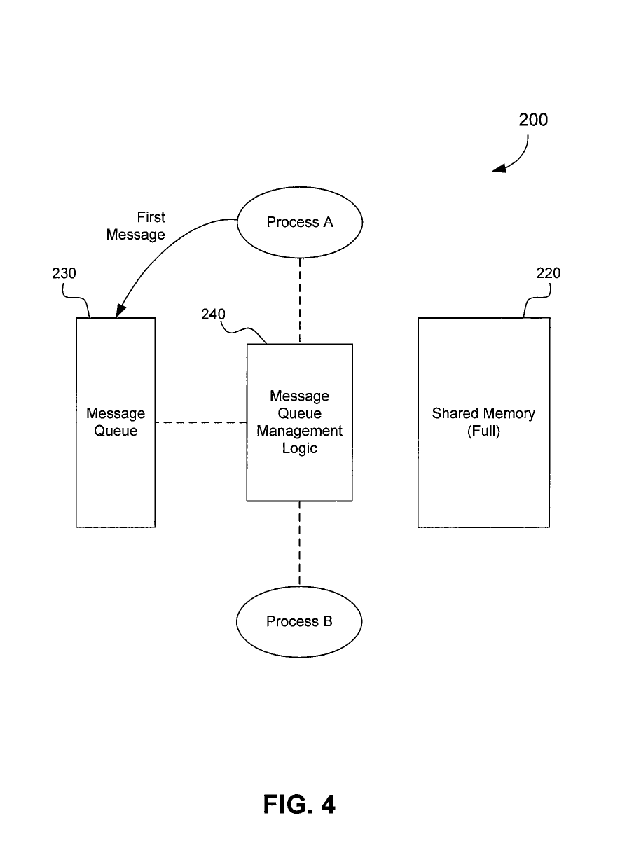

FIG. 4 illustrates that process A has completed the task of writing data to shared memory 220 (i.e., shared memory 220 is full). To signal to process B that shared memory 220 is ready for reading, process A places a first message in message queue 230 (line A2).

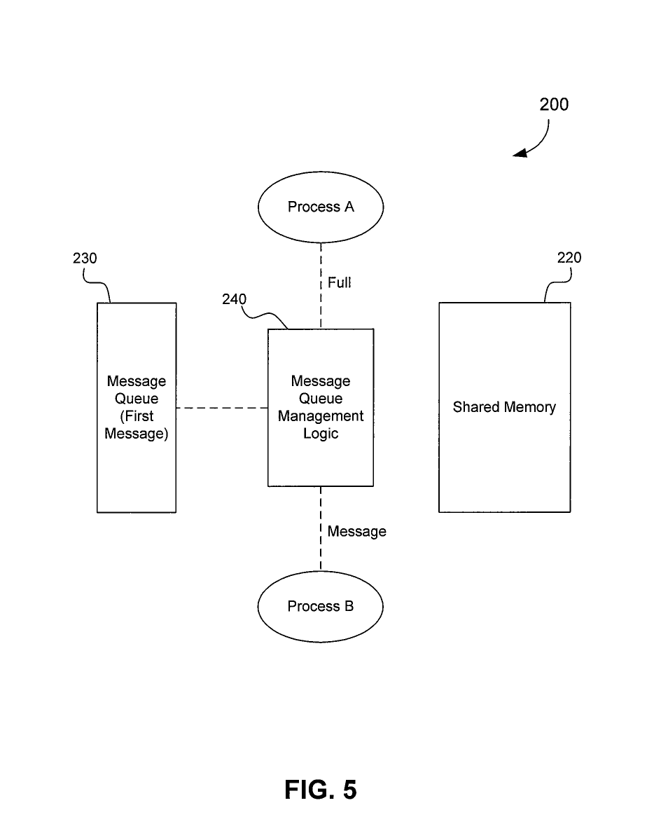

FIG. 5 illustrates the state of secure communication channel 200 after process A places the first message in message queue 230. Process A attempts to place a second message in message queue 230 (line A3), but is blocked by message queue management logic 240 which provides a FULL signal (e.g., the msgsnd call) to process A. Process B receives a MESSAGE indication (e.g., msgrcv) from message queue management logic 240, and immediately pops the first message from message queue 230 (line B1).

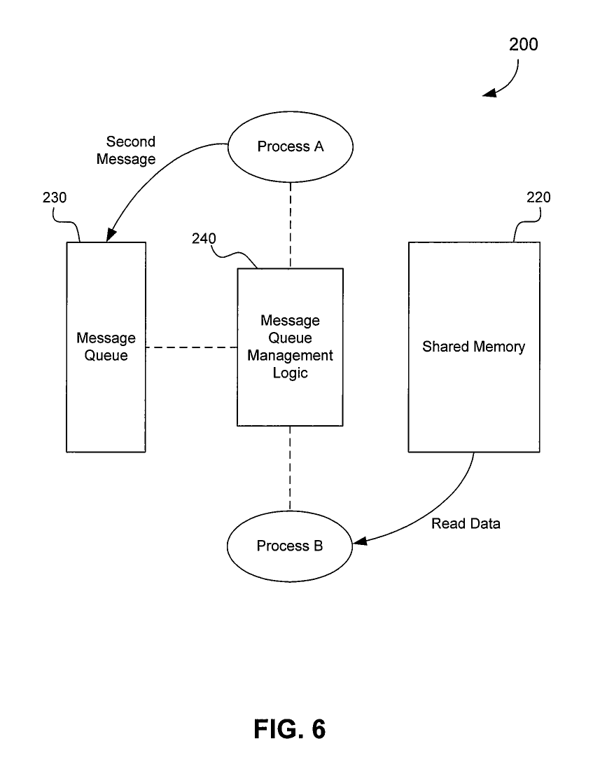

FIG. 6 illustrates the state of secure communication channel 200 after process B pops the first message from message queue 230. Immediately after popping the first message, process B begins processing shared memory 220 (line B2). Message queue management logic 240 indicates that message queue 230 is no longer full, and process A's previous attempt to place the second message on message queue 230 is unblocked and succeeds (line A3).

Referring to line A4, process A writes a third message to message queue 230 to prevent process A from writing new data to shared memory 220 before process B has had a chance to read the old data from shared memory 220. That is, the third message that process A writes to message queue 230 prevents a race condition, as depicted in FIG. 9.

Referring to FIG. 9, process A writes to shared memory 220 during line A1. After writing to shared memory 220, process A writes the first message to message queue 230 (line A2). Process B pops the first message from message queue 230 (line B1), which causes process A's second message to be written to message queue 230. As illustrated in FIG. 9, if process A immediately began writing more data to shared memory 220 after process B popped the first message from message queue 230 (i.e., immediately after process A wrote the second message to message queue 230), process A could write new data to shared memory 220 before process B could read the old data. To prevent this type of data corruption, process A attempts to write the third message to message queue 230 to stall process A.

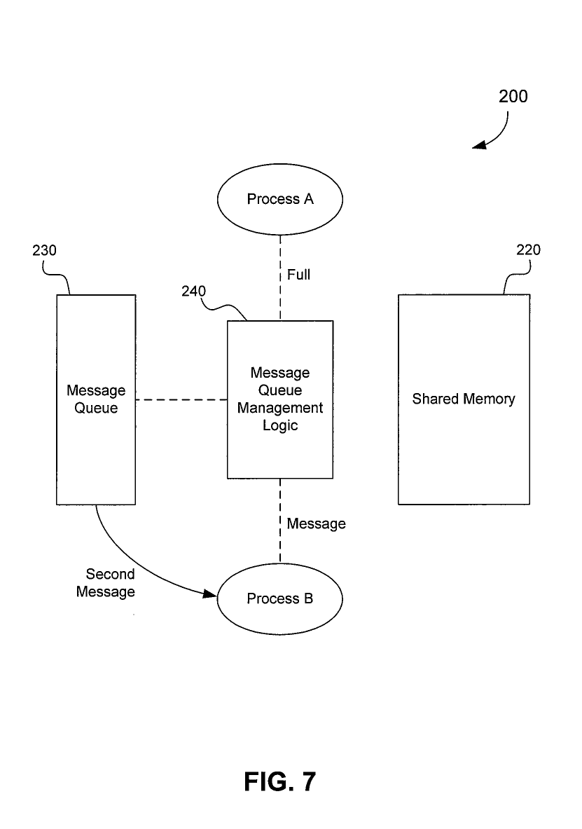

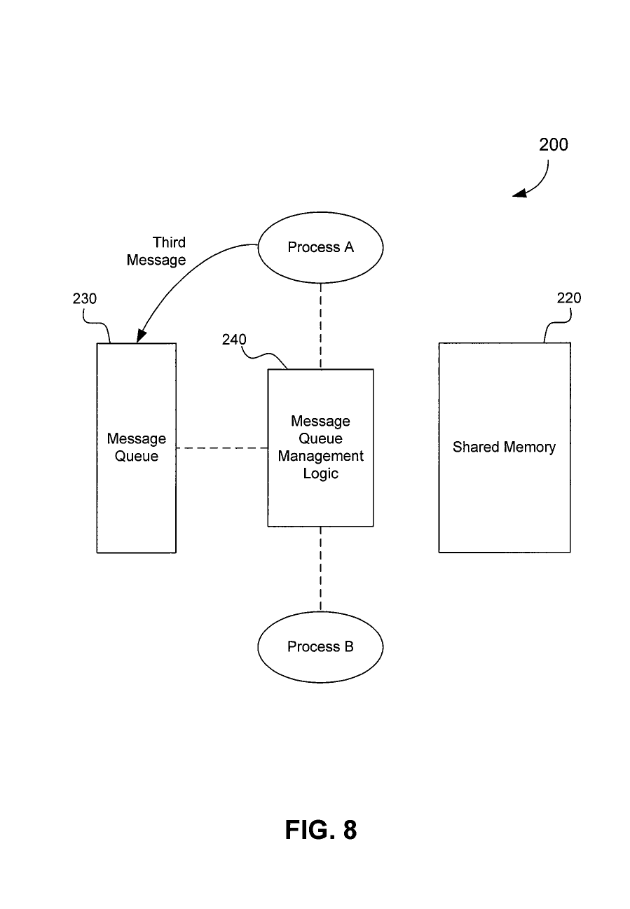

Referring to FIGS. 7 and 8, after process B has read the data from shared memory 220, process B pops the second message from message queue 230 (line B3). Since message queue 230 is now empty as illustrated in FIG. 8, process A's third message can successfully be written to message queue 230 (line A4). Consequently, by emptying message queue 230 (and allowing process A's third message to be written to message queue 230), process B signals to process A that process B has completed reading the data from shared memory 220. As a result, process A can again write data to shared memory 220 (line A5), and the above-described process is repeated.

The above embodiment provides both high-throughput and security. Conventionally, shared memory provides a high-throughput inter-process communications mechanism, but is insecure because of the almost unlimited back channel. This is overcome by the present invention, for example, because the present invention combines the high-throughput capabilities of shared memory with the limited back channel of message queues to provide a secure information flow pipeline.

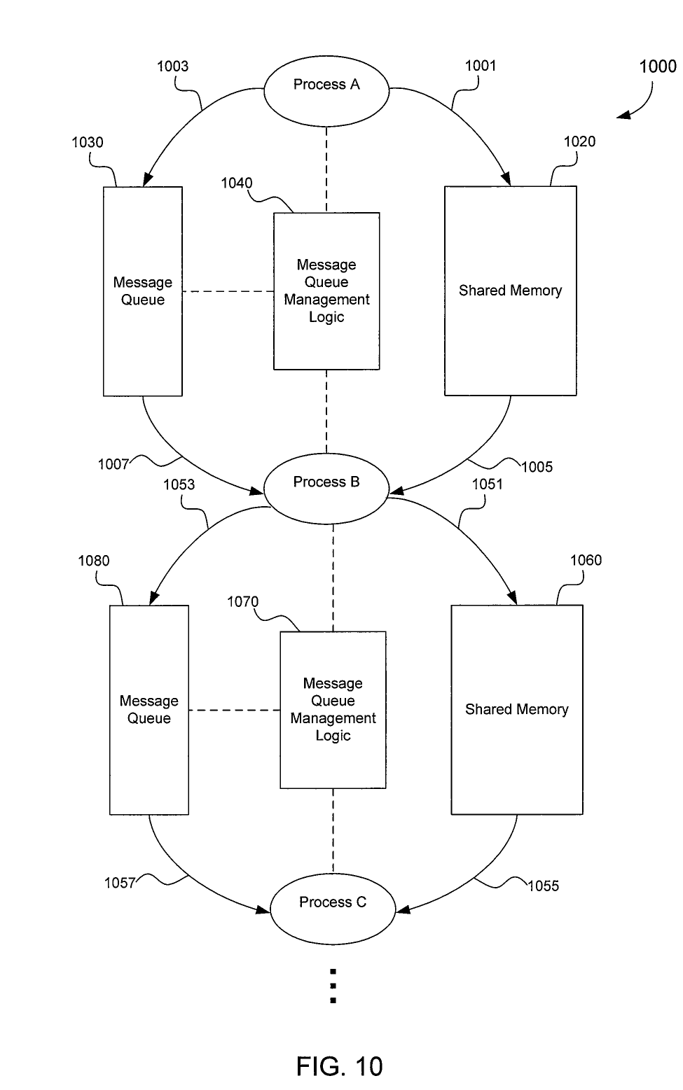

In an embodiment of the present invention, a plurality of secure communication channels are chained together in series as illustrated in FIG. 10. FIG. 10 depicts an example secure communication channel 1000 between process A and process C, via process B, in accordance with an embodiment of the present invention. Secure communication channel 1000 includes a first communication channel between process A and process B, and a second communication channel between process B and process C.

The first communication channel between process A and process B includes a shared memory 1020, a message queue 1030, and message queue management logic 1040.

Shared memory 1020 provides a high-throughput forward data path between process A and process B. Process A has write access to shared memory 1020 via a data path 1001, and process B has only read access to shared memory 1020 via a data path 1005. Shared memory 1020 functions in a similar manner to shared memory 220 described above.

Message queue 1030 provides a path for controlling the flow of data through shared memory 1020, while limiting the backward flow of information from process B to process A. Process A has write access to message queue 1030 via a data path 1003, and process B has only read access to message queue 1030 via a data path 1007. Message queue 1030 functions in a similar manner to message queue 230 described above.

Message queue management logic 1040 communicates the status of message queue 1030 to processes A and B in a similar manner to that described above.

The second communication channel between process B and process C includes a shared memory 1060, a message queue 1080, and message queue management logic 1070.

Shared memory 1060 provides a high-throughput forward data path between process B and process C. Process B has write access to shared memory 1060 via a data path 1051, and process C has only read access to shared memory 1060 via a data path 1055. Shared memory 1060 functions in a similar manner to shared memories 220 and 1020 described above.

Message queue 1080 provides a path for controlling the flow of data through shared memory 1060, while limiting the backward flow of information from process C to process B. Process B has write access to message queue 1080 via a data path 1053, and process C has only read access to message queue 1080 via a data path 1057. Message queue 1080 functions in a similar manner to message queues 230 and 1030 described above.

Message queue management logic 1070 communicates the status of message queue 1080 to processes B and C in a similar manner to that described above.

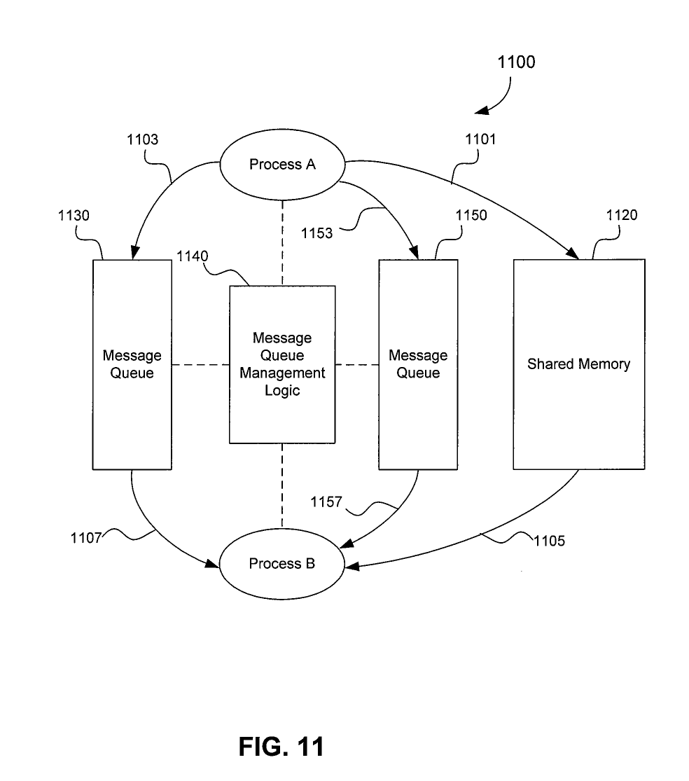

In another embodiment of the present invention, a plurality of message queues are utilized. For example, FIG. 11 depicts an example secure communication channel 1100 between process A and process B, which utilizes a plurality of message queues, in accordance with an embodiment of the present invention. Secure communication channel 1100 includes a shared memory 1120, a first message queue 1130, a second message queue 1150, and message queue management logic 1140.

Shared memory 1120 provides a high-throughput forward data path between process A and process B. Process A has write access to shared memory 1120 via a data path 1101, and process B has read-only access to shared memory 1120 via a data path 1105. Shared memory 1120 functions in a similar manner to shared memory 220 (FIG. 2) and shared memory 1020/1060 (FIG. 10).

First message queue 1130 and second message queue 1150 provide a path for controlling the flow of data through shared memory 1120, while limiting the backward flow of information from process B to process A. Process A has write access to first message queue 1130 via a data path 1103, and write access to second message queue 1150 via a data path 1153. Process B has read-only access to first message queue 1130 via a data path 1107, and read-only access to second message queue 1150 via a data path 1157.

Message queue management logic 1140 communicates the status of first message queue 1130 and second message queue 1150 to processes A and B in a similar manner to that described above.

First message queue 1130 and second message queue 1150 may function in a similar manner to message queue 230 (FIG. 2) to control the flow of data between process A and process B. For example, process A writes to shared memory 1120, and writes a message to first message queue 1130 and second message queue 1150. Process B reads the message from first message queue 1130, reads shared memory 1120, then reads the message from second message queue 1150. After process B reads the message from second message 1150, process A can write a second message to second message queue 1150. Writing the second message to second message queue 1150 can signal process A to restart the algorithm—i.e., to write data to shared memory 1120, and write a message to first message queue 1130 and second message queue 1150. Then the algorithm repeats as described above

It is to be appreciated that secure communication channel 1100 is presented for illustrative purposes only, and not limitation.

### IV. Example Computer System and Software Implementation

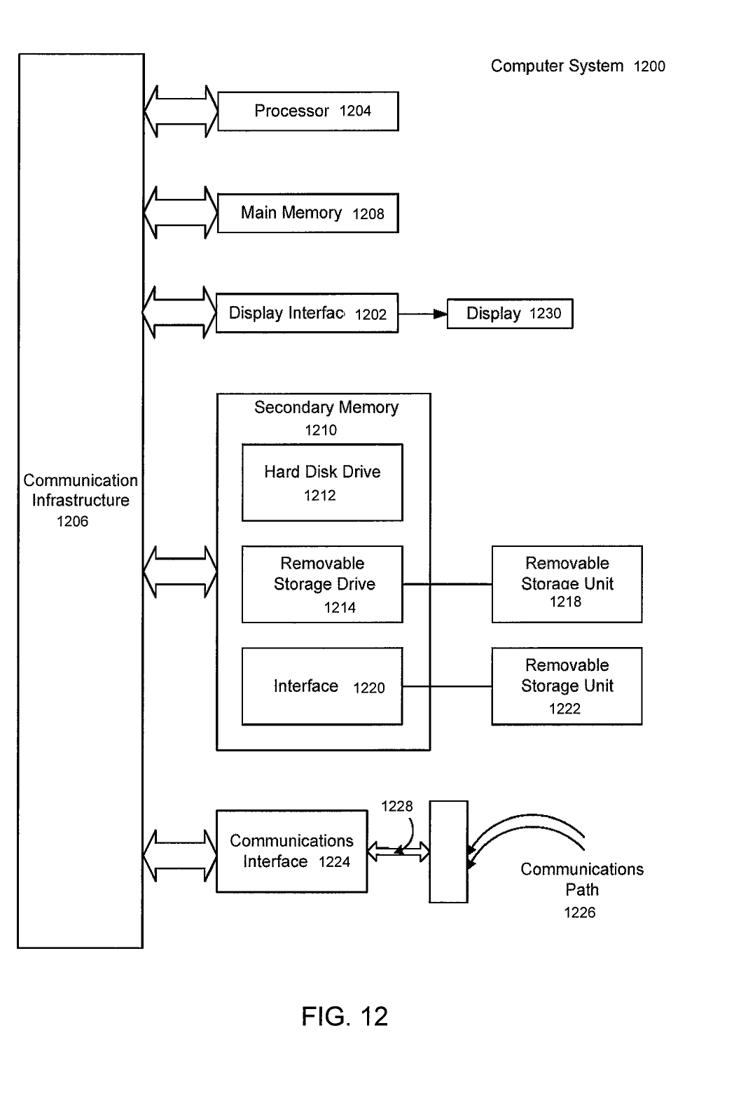

Various aspects of the present invention—such as security policy 104, process A, and process B—can be implemented by software, firmware, hardware, or a combination thereof. FIG. 12 illustrates an example computer system 1200 in which an embodiment of the present invention, or portions thereof, can be implemented as computer-readable code. Various embodiments of the invention are described in terms of this example computer system 1200. After reading this description, it will become apparent to a person skilled in the relevant art how to implement the invention using other computer systems and/or computer architectures.

Computer system 1200 includes one or more processors, such as processor 1204. Processor 1204 can be a special purpose or a general purpose processor. Processor 1204 is connected to a communication infrastructure 1206 (for example, a bus or network).

Computer system 1200 also includes a main memory 1208, preferably random access memory (RAM), and may also include a secondary memory 1210. Secondary memory 1210 may include, for example, a hard disk drive 1212 and/or a removable storage drive 1214. Secondary memory 1210 may include, for example, shared memory 220 and message queue 230, as would be apparent to a person skilled in the relevant art(s). Removable storage drive 1214 may comprise a floppy disk drive, a magnetic tape drive, an optical disk drive, a flash memory, or the like. The removable storage drive 1214 reads from and/or writes to a removable storage unit 1218 in a well known manner. Removable storage unit 1218 may comprise a floppy disk, magnetic tape, optical disk, etc. which is read by and written to by removable storage drive 1214. As will be appreciated by persons skilled in the relevant art(s), removable storage unit 1218 includes a computer usable storage medium having stored therein computer software and/or data.

In alternative implementations, secondary memory 1210 may include other similar means for allowing computer programs or other instructions to be loaded into computer system 1200. Such means may include, for example, a removable storage unit 1222 and an interface 1220. Examples of such means may include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to computer system 1200.

Computer system 1200 may also include a communications interface 1224. Communications interface 1224 allows software and data to be transferred between computer system 1200 and external devices. Communications interface 1224 may include a modem, a network interface (e.g., an Ethernet card), a communications port, a PCMCIA slot and card, or the like. Software and data transferred via communications interface 1224 are in the form of signals 1228 which may be electronic, electromagnetic, optical, or other signals capable of being received by communications interface 1224. These signals 1228 are provided to communications interface 1224 via a communications path 1226. Communications path 1226 carries signals 1228 and may be implemented using wire or cable, fiber optics, a phone line, a cellular phone link, an RF link or other communications channels.

In this document, the terms “computer program medium” and “computer usable medium” are used to generally refer to media such as removable storage unit 1218, removable storage unit 1222, a hard disk installed in hard disk drive 1212, and signals 1228. Computer program medium and computer usable medium can also refer to memories, such as main memory 1208 and secondary memory 1210, which can be memory semiconductors (e.g. DRAMs, etc.). These computer program products are means for providing software to computer system 1200.

Computer programs (also called computer control logic) are stored in main memory 1208 and/or secondary memory 1210. Computer programs may also be received via communications interface 1224. Such computer programs, when executed, enable computer system 1200 to implement embodiments of the present invention as discussed herein, such as the secure inter-process communications described above. In particular, the computer programs, when executed, enable processor 1204 to implement the processes of embodiments of the present invention—including process A and process B, and the secure inter-process communications between process A and process B. Accordingly, such computer programs represent controllers of the computer system 1200. Where the invention is implemented using software, the software may be stored in a computer program product and loaded into computer system 1200 using removable storage drive 1214, interface 1220, hard drive 1212 or communications interface 1224.

### V. Conclusion

Various systems and methods for implementing secure inter-process communications, and applications thereof, have been described in detail herein. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Furthermore, although aspects of the present invention have been described with reference to SELinux, the invention is not limited to the Linux operating system or SELinux. Based on the description contained herein, a person skilled in the relevant art(s) will appreciate that embodiments of the present invention can be implemented with regard to other operating systems.

What is claimed is:

1. A computer-implemented method for securing inter-process communications between a first process and a second process, the first process having write access to a shared memory and a single-entry message queue, the second process having read-only access to the shared memory and the message queue, wherein after the first process writes a first message to the message queue, the first process is blocked from writing a second message to the message queue until after the second process reads the first message from the message queue, the computer-implemented method comprising:
(1) writing data to the shared memory with the first process;
(2) writing a message to the message queue, wherein the message is an indicator to the second process that data is available to be read from the shared memory;
(3) reading the message from the message queue with the second process; and
(4) reading the data from the shared memory with the second process.

2. The computer-implemented method of claim 1, further comprising:
(5) writing a second message and a third message to the message queue with the first process after (2); and
(6) writing data to the message queue with the first process after (5).

3. The computer-implemented method of claim 2, wherein (5) comprises writing messages that cause the second process to take no action.

4. The computer-implemented method of claim 1, further comprising:
(5) reading messages from the message queue after (4) with the second process until a message is received indicating that data is available to be read from the shared memory; and
(6) reading the data from the shared memory with the second process.

5. The computer-implemented method of claim 1, further comprising:
(5) creating the message queue with a third process that is not authorized to write to the message queue.

6. A computer-implemented method for securing inter-process communications, comprising:
passing data from a first process to a second process by writing the data to a shared memory and reading the data from the shared memory, the first process having write access to the shared memory, and the second process having read-only access to the shared memory; and
controlling the passage of data from the first process to the second process by writing messages to at least one message queue and reading messages from the at least one message queue, the first process having write access to the at least one message queue, and the second process having read-only access to the at least one message queue.

7. The computer-implemented method of claim 6, further comprising:
creating the at least one message queue with a third process that is not authorized to write to the at least one message queue.

8. The computer-implemented method of claim 7, wherein the creating comprises creating at least one single-entry message queue.

9. The computer-implemented method of claim 6, wherein the controlling comprises writing a message to a first message queue with the first process that indicates there is data available to be read from the shared memory.

10. The computer-implemented method of claim 6, wherein the controlling comprises reading a message from a first message queue with the second process after data in the shared memory has been read by the second process.

11. The computer-implemented method of claim 6, wherein the controlling comprises blocking the first process from writing a message to the at least one message queue until a message previously written to the at least one message queue by the first process is read from the at least one message queue by the second process.

12. The computer-implemented method of claim 11, wherein the controlling comprises blocking the first process from writing a message to the at least one message queue when the at least one message queue is full.

13. A system for providing secure inter-process communications, comprising:
a memory comprising a message queue adapted to store a message, and a shared memory adapted to store data; and
a processor adapted to execute a first process having write access to the message queue and the shared memory, and a second process having only read access to the message queue and the shared memory,
wherein the first process writes data to the shared memory responsive to a first predetermined number of messages that the first process writes to the message queue, and
wherein the second process reads the data from the shared memory responsive to a second predetermined number of messages that the second process reads from the message queue.

14. The system of claim 13, wherein the second process empties the message queue each time the second process reads a message from the message queue.

15. The system of claim 14, wherein the first process writes data to the shared memory after the second process empties the message queue a predetermined number of times.

16. The system of claim 13, wherein the first process fills the message queue each time the first process writes a message to the message queue.

17. The system of claim 16, wherein the first process is blocked from writing a message to the message queue when the message queue is full.

18. The system of claim 17, wherein the second process reads data from the shared memory after the first process fills the message queue a predetermined number of times.

19. A computer-implemented method for securing inter-process communications, comprising:
passing data from a first process to a second process using a first inter-process communication (IPC) channel of a first type, the first process having write access to the first IPC channel and the second process having read-only access to the first IPC channel; and
controlling the passage of data from the first process to the second process using a second IPC channel of a second type, the first process having write access to the second IPC channel and the second process having read-only access to the second IPC channel;
wherein the second IPC channel has a blocking characteristic which prevents the first process from writing to the second IPC channel when a capacity of the second PC channel is met, and
wherein the second process signals the first process to pass the data based on the blocking characteristic.

20. The computer-implemented method of claim 19, further comprising:
creating the second IPC channel with a third process that is not authorized to write to the second IPC channel.

21. The computer-implemented method of claim 19, further comprising:
creating the second IPC channel to comprise at least one single-entry message queue.

22. The computer-implemented method of claim 19, wherein the controlling comprises writing to the second IPC channel with the first process, thereby indicating there is data available to be read from the first IPC channel.

23. The computer-implemented method of claim 19, wherein the controlling comprises reading a message from the second IPC channel with the second process after data in the first IPC channel has been read by the second process.
